(19) United States
(12) Patent Application Publication
(10) Pub. No.: US 2007/0166000 A1
(43) Pub. Date: Jul. 19, 2007

(54) System and method for generating trick mode streams

(76) Inventors: Ramesh Nallur, Suwanee, GA (US); Jianxin Ren, Lawrenceville, GA (US); Hank Guo, Suwanee, GA (US); Peter Chan, Suwanee, GA (US); Ben Cook, Flowery Branch, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/069,297

(22) Filed: Mar. 1, 2005

(51) Int. Cl. H04N 5/91

(52) U.S. Cl. 386/68

(57) ABSTRACT

Disclosed are systems and methods for creating a trick mode stream. A digital home communication terminal (DHCT) comprises a network interface, a storage medium, at least one memory storing program code; and at least one processor programmed by at least the program code. The network interface is in communication with a second DHCT. The program code enables the DHCT to: select a first encoded picture frame from a recorded video stream on the storage medium; retrieve a first sequence of transport packets encapsulating the first picture frame; create a first transport packet containing a first client control packet associated with the first picture frame; and transmit, to a video decoder in the second DHCT, a trick mode stream comprising the first transport packet followed by the first sequence of transport packets. The first client control packet comprises the size of the first picture frame and a decoder command.

### TECHNICAL FIELD

The present disclosure is generally related to trick mode streams in digital video recorders, and more specifically, to trick mode streams in distributed digital video recorder systems.

### BACKGROUND

Many consumers receive entertainment programming in their homes from a cable television operator. Many of today's cable offerings are broadcast using digital signals, which make more efficient use of communication bandwidth, and thus allow more programming to be carried on the same cable. In these cable systems, video programming (e.g., television programs, movies, etc.) is encoded at the cable head-end using a Motion Pictures Experts Group (MPEG) standard. The programming is transmitted from the head-end to the customer premises over a cable. At the customer premises, a digital home communication terminal (DHCT) decodes the programming and generates an analog picture signal. The analog picture is displayed by a television connected to the DHCT.

Some of today's DHCT units incorporate digital video recorder (DVR) functionality, which allows the DHCT to record video programming in digital form. These DHCTs can decode and display a video program in real-time from the head-end, or can decode and display a recorded program. A variation on the basic DHCT DVR is a distributed DVR system: a network of DHCT units, with one DHCT acting as the recorder and another acting as the player.

Popular DVR features include the ability to fast-forward, rewind, and pause a recorded program. These features are sometimes referred to as “trick modes.” Implementing trick modes often includes displaying frames at a faster or slower rate. Some trick modes also involve selecting only a subset of frames to decode and display. For example, fast-forwardx2 may choose frames 500 ms apart, and display them every 250 ms, while fast-forwardx4 may choose frames 500 ms apart and displaying them every 1000 ms. Pause can be implemented by decoding and displaying the same frame repeatedly.

There are several problems associated with implementing trick modes in a distributed DVR system. Video frames in the MPEG stream contain presentation timestamps that tell the decoder when to display a particular frame and/or decoder timestamps that tell the decoder when to decode a particular frame. The clock reference for these timestamps is provided by a program clock reference (PCR) that is also embedded in the MPEG stream. When the DVR records a video program, it records the stream as sent by the head-end, including the timestamps and the PCR. When this same stream is sent to the player DHCT in a trick mode, the clock reference provided by the PCR is incomplete, since many frames are skipped. Thus, the decoder in the player DHCT cannot rely on a clock recreated from the received PCR. Furthermore, even if the PCR was good, not every video frame in the MPEG stream has a timestamp. For at least these reasons, the distributed DVR system cannot use recorded PCR and timestamps for decoder timing.

Another approach is for the player DVR to generate a timestamp similar to a local PCR, and to transmit this timestamp in the stream. However, on many DHCTs, the recorded stream is stored in encrypted form, so that altering it requires first decryption and then re-encryption. The computational power required for this makes this approach infeasible.

In addition to these problems related to timing, there are other problems as well. When a state transition occurs from, for example, fast-forward mode to play mode, the decoder must know at exactly which frame this transition occurs. Otherwise, improper decoding will occur and the user will see artifacts. In a typical integrated DVR, this is easily accomplished. Since the video source resides in the same unit as the decoder, communication between the two occurs at relatively high bus speeds. Thus, the source can receive state change information back from the decoder before any further frames are communicated to the decoder. In contrast, communication between the recorder (source) and the player (decoder) in a distributed DVR system takes place at network speeds, which are much slower than bus speeds. This communication mechanism is often not fast enough to accurately communicate state transitions to the decoder.

### DESCRIPTION OF THE DRAWINGS

FIG. 1 is a block diagram of the environment of the system for generating trick mode streams.

FIG. 2 is a block diagram illustrating selected components of one embodiment of the DHCT of FIG. 1.

FIG. 3 illustrates several different picture types defined by the MPEG standard.

FIG. 4 illustrates the process of packetizing an elementary video stream.

FIG. 5 illustrates segmentation of the video stream of FIG. 4 into an MPEG transport stream.

FIG. 6 illustrates a stored transport stream consisting of TS packets encapsulating the video elementary stream of a user-specified program.

FIG. 7 is a flow chart illustrating the actions taken by trick mode logic in a server DHCT.

FIG. 8 is a diagram of example trick mode transport stream created by trick mode logic in a server DHCT.

FIG. 9 is a flow chart illustrating the actions taken by trick mode logic in a client DHCT.

### DETAILED DESCRIPTION

In one embodiment, among others, the method supports trick modes in a distributed DVR system by inserting trick mode control packets into the MPEG stream sent from the recorder to the player. The decoder in the player relies on instructions in these control packets to determine the time at which frames are decoded rather than using timestamps in the originally received stream. Specifically, these instructions tell the decoder how many bytes should be buffered before decoding begins, and when a buffer of frames should be displayed. In one embodiment, the recorder sends a trick mode control packet, followed by the selected I-frame, followed by the picture header of the next frame, and then the sequence repeats with the next selected I-frame. In some embodiments, the control packet also contains additional information such as: ignore timestamps beginning with this frame; disable audio beginning with this frame; current trick mode (normal play, fast-forwardx2, fast-forwardx4, rewind, slow-motion, etc.); and whether the current stream contains I-frames or not.

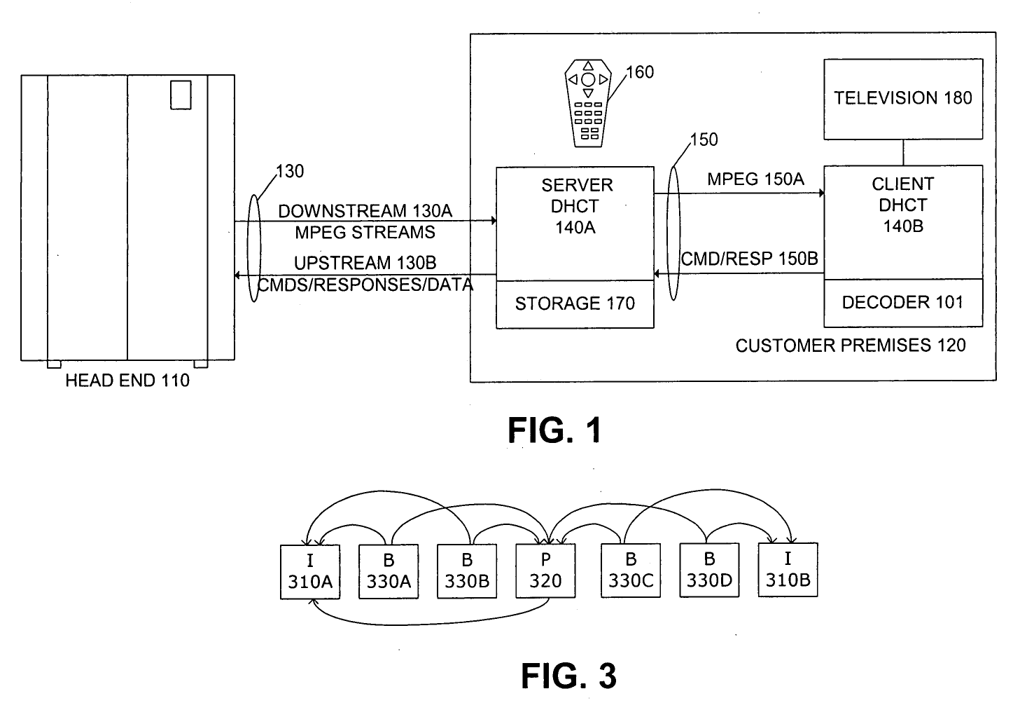

FIG. 1 is a block diagram of the environment of the system for generating trick mode streams. Head-end 110 provides digital services (video, audio and/or data) to customer premises 120 over bi-directional communication channel 130. These services may include, for example, broadcast television services, cable television services, premium television services, video-on-demand (VOD) services, pay-per-view (PPV) services, and/or Internet data services, among others. In one embodiment, communication channel 130 is a hybrid fiber-coax (HFC) cable. Other delivery mechanisms are also contemplated, for example, satellite, and/or satellite in combination with a cable or a telephone line.

The standard used by head-end 110 is the MPEG-2 standard, which describes how video and audio are compressed and coded to produce elementary streams. The MPEG-2 standard also describes how the elementary streams are multiplexed, transmitted, and demultiplexed, and how synchronization is achieved between elementary streams. Head-end 110 transmits multiplexed MPEG streams containing video, audio, and/or data to customer premises 120 over communication channel 130 (in the “downstream” direction). Typically, the downstream communication channel 130A contains one or more RF channels or frequencies, and each of these RF channels carries one MPEG transport stream. The MPEG transport stream is multiplexed to carry multiple elementary streams. For simplicity, the remainder of this discussion will discuss a single RF channel carrying an MPEG transport stream.

Customer premises 120 contains at least two DHCTs, 140A and 140B. In one embodiment, a DHCT is a standalone, integrated unit. In another embodiment, a DHCT is integrated into another consumer device, such as a television, among others. Server DHCT 140A receives streams over downstream channel 130A. Server DHCT 140A transmits commands, responses, and data to head-end 110 over upstream communication channel 130B. Client DHCT 140B is not in direct communication with head-end 110, but is coupled to server DHCT 140A via home network 150. Remote control 160 allows users to control one or more of the DHCT units.

Server DHCT 140A has the capability to record MPEG transport streams received from head-end 110 onto a storage medium 170. Server DHCT 140A can also transmit a recorded stream to client DHCT 140B over channel 150A, which is part of network 150. Channel 150A is also used to communicate commands and responses to client DHCT 140B. An MPEG decoder in client DHCT 140B decodes the stream and provides it to television 180 for display. Client DHCT 140B can transmit commands, responses, and status information to server DHCT 140A over channel 150B, which is part of network 150. In one embodiment, server DHCT 140A also includes a MPEG decoder and provides it to an attached television (not shown).

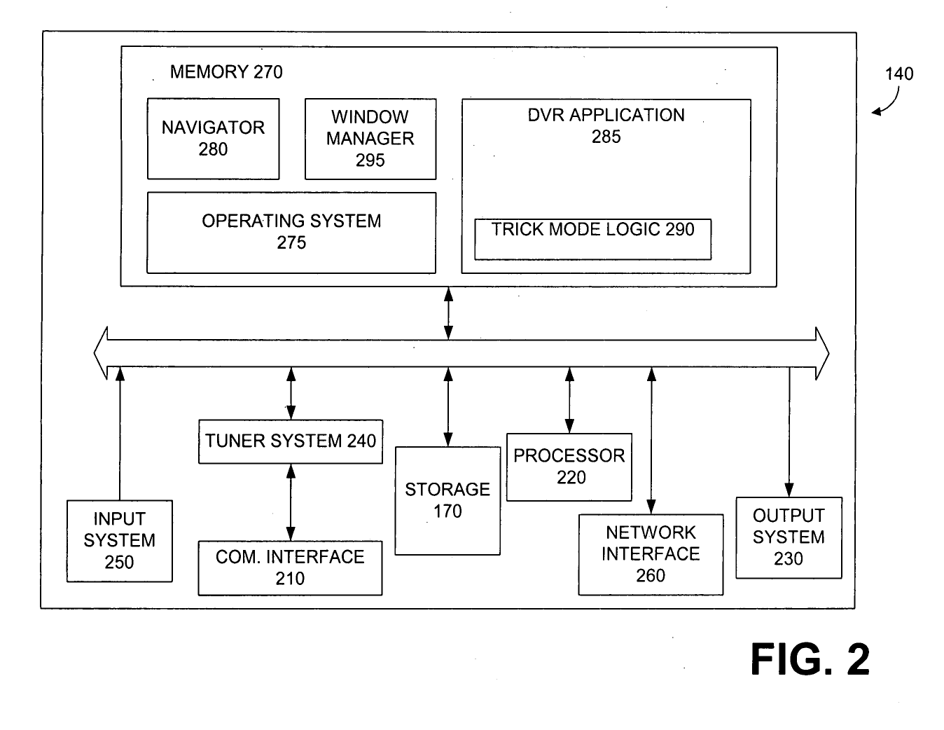

FIG. 2 is a block diagram illustrating selected components of one embodiment of DHCT 140A or 140B from FIG. 1. DHCT 140 comprises a communications interface 210 for receiving video, audio and other data from head-end 110 (FIG. 1), and for providing reverse information to head-end 110. DHCT 140 further includes at least one processor 220 for controlling operations of DHCT 140, an output system 230 for driving a display device (e.g., television 180), and a tuner system 240. Tuner system 240 tunes to a particular television service to be displayed via the display device, and sends and receives various types of data to/from head-end 110. Tuner system 240 includes in one implementation, an out-of-band tuner for bi-directional quadrature phase shift keying (QPSK) data communication and a quadrature amplitude modulation (QAM) tuner for receiving television signals. Input system 250 receives user inputs that are provided via an input device such as, for example, remote control 160 (FIG. 1), a transmitter with buttons or keys located on the exterior of the DHCT, or a keyboard.

Network interface 260 is an interface for transmitting and/or receiving data to/from another DHCT. Network interface 260 may comprise, for example, an Ethernet interface, an IEEE-1394 interface, a USB (Universal Serial Bus) interface, a serial interface, a parallel interface, a wireless radio frequency (RF) interface, a telephone line interface, a power line interface, a coaxial cable interface, and/or an infrared (IR) interface, among others. In one possible implementation, the network interface 260 is an Ethernet interface, which is coupled one or more DHCTs via an Ethernet hub.

Memory 270, which may include volatile and/or non-volatile memory, stores one or more programmed software applications, herein referred to as applications, which contain instructions that may be executed by processor 220 under the direction of operating system 275. Input data used by an application is stored in memory 270 and read by processor 220 as needed during the course of the application's execution. This input data may be data stored in memory 270 by a secondary application or other source, either internal or external to DHCT 140, or may be data that was created with the application at the time it was generated as a software application program. Data transmitted by head-end 110 may be received via communications interface 210, whereas user input may be received from an input device via input system 250. Data generated by an application is stored in memory 270 by processor 220 during the course of the application's execution. Availability, location, and amount of data generated by one application for consumption by another application are communicated by messages through the services of operating system 280.

A navigator application 280 provides a navigation framework for services provided by DHCT 140. Navigator 280 registers for and in some cases reserves certain user inputs related to navigational keys such as channel increment/decrement, last channel, favorite channel, etc. Navigator 280 also provides users with television related menu options that correspond to DHCT functions such as, for example, providing an interactive program guide, blocking a channel or a group of channels from being displayed in a channel menu, and displaying a purchase list for a video-on-demand service.

Under user instruction, DVR application 285 records and/or and plays back received programs. DVR application 285 includes trick mode logic 290. When this system is used to implement server DHCT 140A, trick mode logic 290 creates a trick mode stream corresponding to the recorded stream, and provides it to client DHCT 140B using network interface 260. When this system is used to implement client DHCT 140B, trick mode logic 290 decodes and display the received trick mode stream.

Applications, such as navigator 280 and DVR 285, utilize services provided by window manager 295 and other graphics utilities provided by operating system 275 to draw menus, graphics, etc. for display on television 180. Window manager 295, which in one embodiment is part of operating system 275, contains functionality for allocating screen areas and managing screen use among multiple applications.

Applications executed by DHCT 140 comprise executable instructions for implementing logical functions. The applications can be embodied in any computer-readable medium for use by or in connection with an instruction execution system. The instruction execution system may be, for example, a computer-based system, a processor-containing system, or any other system capable of executing instructions. In the context of this document, a “computer-readable medium” can be any means that can contain, store, communicate, propagate, or transport the program for use by or in connection with the instruction execution system, apparatus, or device.

The computer-readable medium can be, for example, but is not limited to, an electronic, solid-state, magnetic, optical, electromagnetic, infrared, or semiconductor system, apparatus, device, or propagation medium, either internal to DHCT 140 or externally connected to DHCT 140 via one or more communication ports or network interfaces. More specific examples (a non-exhaustive list) of the computer-readable medium would include the following: an electrical connection (electronic) having one or more wires, a portable computer diskette (magnetic), a hard drive storage device (magnetic), a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The programming streams provided to DHCT 140 by head-end 110 preferably follow the MPEG-2 set of standards. This set of standards describes how video and audio are compressed and coded to produce elementary streams. The MPEG-2 standards also describe how the elementary streams are multiplexed, transmitted, and demultiplexed, and how synchronization is achieved between elementary streams.

The MPEG-2 standards use the three different picture types shown in FIG. 3 to encode video: I-frames (310A and 310B); P-frames (320); and B-frames (330A-D). An I-frame (intra-frame) is encoded as a single run-length encoded image, independent of any past or future frames. A P-frame (forward predictive frames) is encoded relative to the closest preceding reference frame (I-frame or P-frame). A B-frame (bi-directional predictive frames) is encoded relative to the closest preceding reference frame, the closest following reference frame (I or P), or both frames.

The arrows in FIG. 3 show the dependencies that exist in an example sequence of MPEG video frames. The single P-frame 320 is dependent on the first I-frame 310A. The first two B-frames 330A and 330B are both dependent on the preceding I-frame 310A, and are also dependent on P-frame 320. In the second group of B-frames, 330C and 330D, each is dependent on the single P-frame 320, and is also dependent on the succeeding I-frame 310B.

Although the word “frame” is used, an MPEG frame or picture is not equivalent to what is normally called a “movie frame” or “video frame,” since it may not contain enough information to decode and display an entire image. A single I-frame plus some number of P-frames and/or B-frames forms a group of pictures, or GOP, which is guaranteed to contain the information to properly decode and display an image. Thus, a GOP is equivalent to a “movie frame.” GOPs can be arranged in a sequence. All pictures in a sequence have the same picture size, aspect ratio, and frame rate.

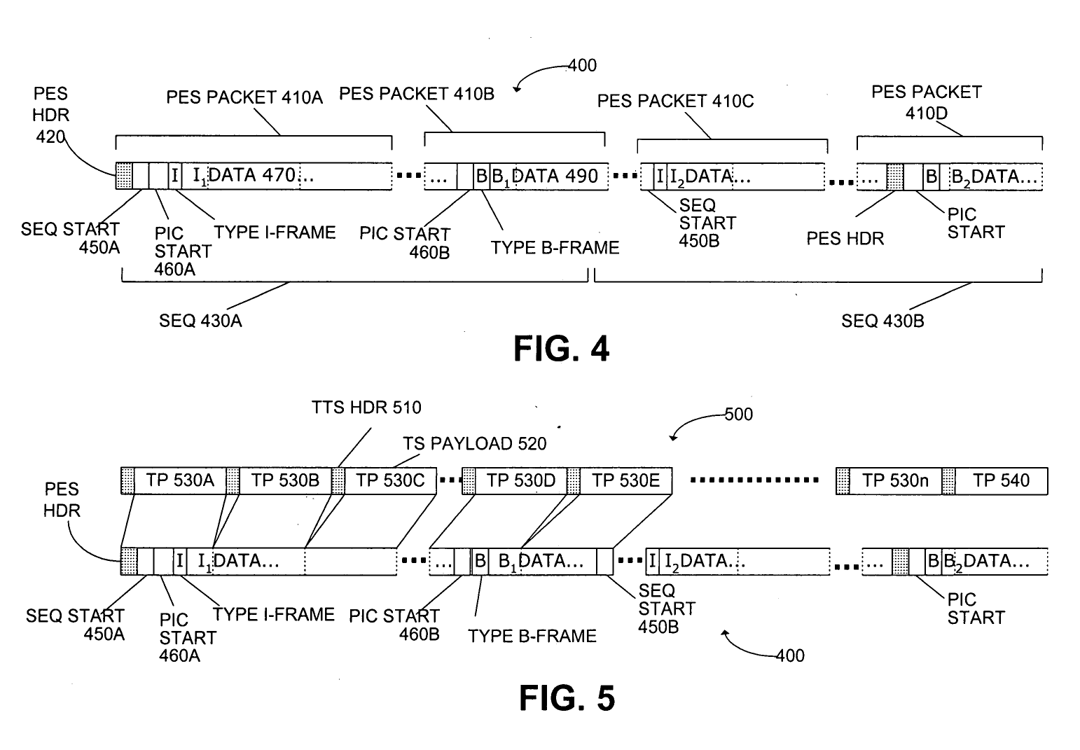

Before a video stream is transmitted from a video source such as head-end 110, the frames are first packetized. This process is shown in FIG. 4. Video stream 400 is an elementary stream, and as such is composed of relatively long variable-length packets called Packetized Elementary Stream (PES) packets. There are four PES packets in FIG. 4, 410A-D. Each PES packet begins with a PES header 420, followed by a variable amount of data. (The last PES packet 410D is only partially shown in this figure.)

The MPEG standard allows the data portion of a PES packet to contain MPEG units described above, where each element begins with a start code. The example embodiments discussed here all contain one picture per PES packet. Video stream 400 contains two sequences, 430A and 430B, each beginning with a sequence start code (450A and 450B). Both sequences contain one I-frame and one B-frame. The I-frame of the first sequence 430 starts with picture start code 460A, followed by I-data 470. This I-frame is immediately followed by another B-frame, which starts with picture start code 460B, followed by B1-data 490.

There is no sequence end code. Instead, the start of the second sequence 430B is marked by a second sequence start code (450B). The format of the two frames in this sequence is the same as in the first sequence: picture start code followed by data.

The large size of PES packets makes them suitable for storage media, but not as suitable for transmission over error-prone communication channels. For transmission, PES packets are first segmented and then encapsulated into relatively small fixed-size packets called Transport Stream (TS) packets.

FIG. 5 illustrates the segmentation of Video stream 400 from FIG. 4 into MPEG transport stream 500. Each TS packet in transport stream 500 starts with a TS header 510, followed by the TS payload 520. The payload of the first TS packet 530A contains only a portion of the first PES packet 410A. Because PES packets are large relative to TS packets, it takes many TS packets to carry a single PES packet. Successive TS packets 530B-530n carry the rest of PES packet 410A. This can be seen in FIG. 5, where dotted lines mark the PES stream into TS-sized blocks, each of which corresponds to one TS packet. Immediately following TS packet 530n (carrying the end of PES packet 410C) is a TS packet 540 carrying the fourth PES packet 410D.

Server DHCT 140A receives an MPEG transport stream like the one of FIG. 5, and can record the transport stream onto a recordable storage medium 170. This record capability is typically under user control, such that a user can interact with server DHCT 140A to initiate a recording of a specific program (i.e., movie, television program, etc.) at a future time, or to initiate a recording of a specific program at the current time. Since an MPEG transport stream is multiplexed and carries multiple programs, server DHCT 140A does not record every TS packet in a particular transport stream. Instead, server DHCT 140A records only the elementary streams associated with the user-specified program. Thus, server DHCT 140A acts, while recording, to filter out other TS packets that are not associated with this program.

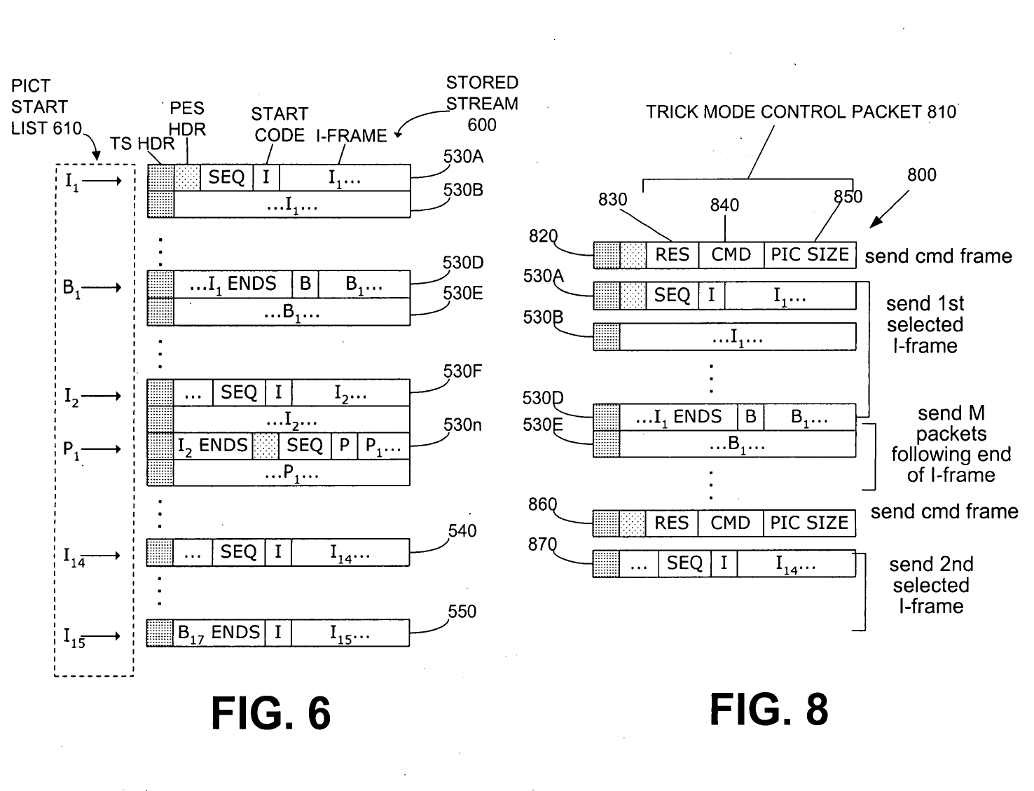

FIG. 6 illustrates a stored transport stream 600 consisting of TS packets encapsulating the video elementary stream of a user-specified program. Although at least one audio stream is also associated with the program and stored on storage medium 170, only the video stream is shown since no audio is provided during trick mode play. The video elementary stream of FIG. 6 is the same video stream 400 of FIGS. 4 and 5. As before, only a portion of the TS packets is shown, since a single MPEG video frame takes up many TS packets. The TS packets are shown as contiguous in FIG. 6, but it is not necessary that they be stored contiguously on the storage medium.

When in trick mode, server DHCT 140A selects a subset of the TS packets in stored transport stream 600 for transmission to client DHCT 140B. (The selection process will be discussed in more detail later.) Picture start list 610 stored on storage medium 170 allows server DHCT 140A to efficiently locate TS packets containing picture frames. Picture start list 610 is a list of all MPEG pictures in the stored transport stream 600, along with a reference to the TS packet containing the start code for that picture. For example, stored transport stream 600 contains five MPEG pictures: I₁; B₁; I₂; P₁; I₁₄; and I₁₅. Picture start list 610 therefore contains the following entries: I₁, starts in TS packet 530A; B₁ starts in TS packet 530D; I₂ starts in TS packet 530F; P₁ starts in TS packet 530n; I₁₄ starts in TS packet 540; and I₁₅ starts in TS packet 550.

Picture start list 610 is useful when the recorded TS packets are encrypted and server DHCT 140A cannot examine the TS payload contents to look for picture start codes. In this case, picture start list 610 is created as stored transport stream 600 is recorded, which involves temporarily decrypting the TS packets. In another embodiment, stored transport stream 600 is not encrypted, and a separate picture start list 610 is unnecessary because server DHCT 140A can scan the TS payloads for picture start codes.

To implement trick mode, trick mode logic 290 in server DHCT 140A creates a trick mode stream corresponding to a recorded stream, by inserting trick mode command packets into the stream transmitted to client DHCT 140B. Trick mode logic 290 in server DHCT 140A also paces the transmission of picture frames according to the selected trick mode. For example, when the mode is fast-forwardx2, twice as many pictures frames are transmitted in the same time period, compared to normal play. Trick mode logic 290 in client DHCT 140B relies on instructions in these command packets to determine the time at which frames are decoded rather than using timestamps in the received stream. These instructions tell the decoder how many bytes should be buffered before decoding begins, and when a decode frame should be displayed. In some embodiments, the command packet also specifies additional information such as: ignore timestamps beginning with this frame; disable audio beginning with this frame; current trick mode (normal play, fast-forwardx2, fast-forwardx4, rewind, slow-motion, etc.); and whether the current stream contains I-frames or not.

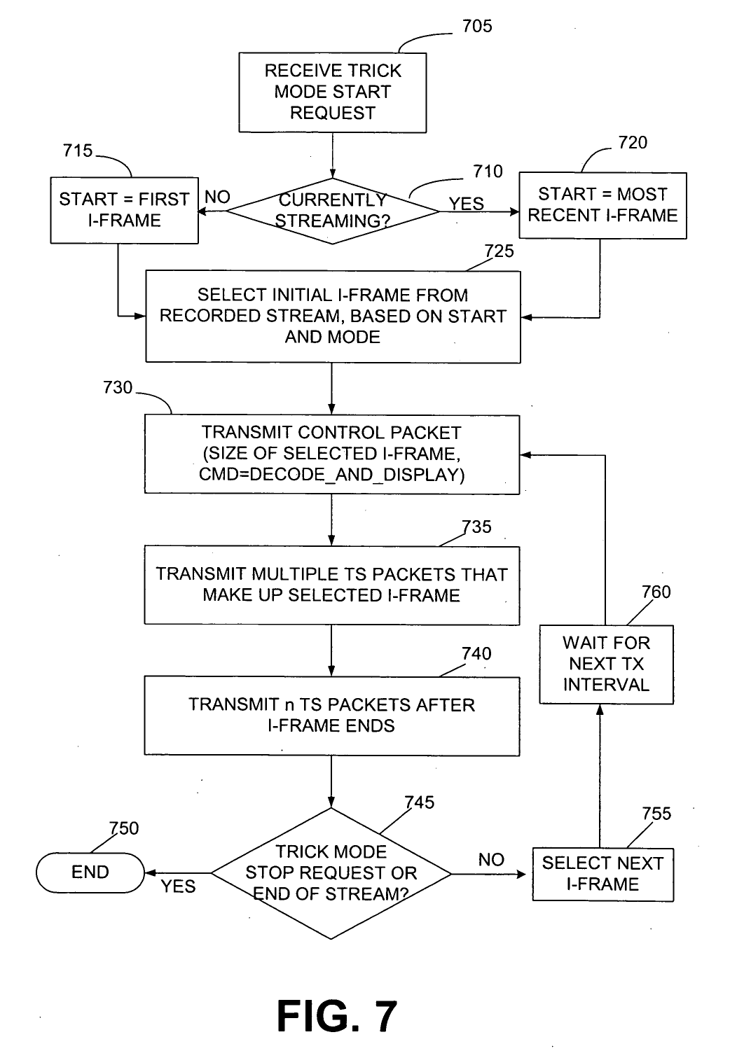

FIG. 7 is a flow chart illustrating one example of actions taken by trick mode logic 290 in server DHCT 140A. In accordance with one embodiment of the method of generating trick mode streams, server DHCT 140A selects and transmits a subset of I-frames from stored transport stream 500, where the number of frames and the transmission interval is chosen to maintain the trick mode speed. The process begins in step 705, where server DHCT 140A receives a request to start trick mode from client DHCT 140B. Since there are multiple trick modes, the request identifies the trick mode, for example, the direction and speed (e.g., fast-forwardx2, rewindx2) and/or type (e.g., pause, slow-motion). The request is received over channel 150A. The details of the request protocol used to communicate this request to server DHCT 140A are not important to the system and method for generating a trick mode stream. The request protocol will not be discussed further, as examples of such would be understood by those reasonably skilled in the art of the present disclosure.

On receipt of the trick mode request, server DHCT 140A determines the correct start position within the recorded stream. This is accomplished by first determining, in step 710, whether it is currently transmitting the recorded stream to client DHCT 140B. If No, the process continues at step 715, where the start position is initialized to the first I-frame in the recorded stream. If Yes, the process continues at step 720, where the start position is initialized to the most recently transmitted I-frame in the recorded stream.

After the start position is initialized, server DHCT 140A selects a series of I-frames to be transmitted to client DHCT 140B. At step 725, the first I-frame is selected, based on the start position and the specific mode selected. For example, if the start position is the last frame in the recorded stream and the mode is rewindx2, then the first selected I-frame is the I-frame 500 ms before the last frame. In another example, if the start position is the first frame and the mode is slow-motion, then the first selected I-frame is the first I-frame in the recorded stream. Further details about the selection criteria used by an example embodiment of the system for generating trick mode streams are found in Table 1.

TABLE 1

| | Selection | Transmit | | |
|---|---|---|---|---|
| Trick Mode | Criteria | Interval | | Decoder Command |
| fast-forward ×2 | I-frame 500 | 250 | ms | Decode_and_Display |
| fast-forward ×4 | ms forward | 125 | ms | |
| fast-forward ×6 | | 83 | ms | |
| fast-rewind ×2 | I-frame 500 | 250 | ms | |
| fast-rewind ×4 | ms backward | 125 | ms | |
| fast-rewind ×6 | | 83 | ms | |
| pause | select same | 500 | ms | |
| | I-frame | | | |
| slow motion | select | 500 | ms | |
| forward | next frame | | | |

| | | |
|---|---|---|
| frame-advance | select | not applicable |
| | next frame | (send frame |
| | (I-frame, | once) |
| | B-frame or | |
| | P-frame) | |
| frame-reverse | select | not applicable |
| | previous | (send frame |
| | I-frame | once) |

Once an I-frame is selected, server DHCT 140A continues to step 730 where a trick mode control packet is created and transmitted to client DHCT 140B. The control packet contains the total size of the transport packet payloads following the control packet, and a decoder command. The decoder command instructs the decoder in client DHCT 140B how to handle the picture frame once it has been received in the decoder's buffer. The decoder command depends on the characteristics of the recorded stream. If the recorded stream contains I-frames, then the decoder command is Decode_and_Display. If the recorded stream contains no I-frames, the command is Decode_Only. In one embodiment, the command Normal_Play is also supported. Normal_Play tells the decoder to decode the stream normally.

Server DHCT 140A then continues to step 735 and transmits all the TS packets that make up the selected I-frame. In one embodiment, server DHCT 140A uses picture start list 510 to find the TS packet containing the start of a particular picture frame. Note that there may be PES packets with a non-zero length field. The last such PES packet containing I-frame data may be incomplete as a result of the selection. For those PES packets, additional stuffing TS packets are added so that the PES packets are complete. At step 740, after transmitting the entire I-frame, server DHCT 140A transmits an additional number (M) of TS packets following the last TS packet containing the selected I-frame. These additional TS packets allow the decoder to skip the data of the next picture frame in a clean manner. (This feature will be described in connection with FIG. 8.) The size field in the control packet includes the size of the selected I-frame plus the additional TS packets.

Next, server DHCT 140A determines if processing of this trick mode stream is complete. At step 745, server DHCT 140A determines if either a trick mode stop request has been received, or the end of the recorded stream has been reached. If one of the these conditions is TRUE, trick mode stream processing ends, at step 750. If client DHCT 140B has requested server DHCT 140A to stop the trick mode stream, server DHCT 140A transmits a trick mode control packet indicating the end of the trick mode stream.

If neither condition is true, trick mode stream processing continues at step 755, where the next I-frame is selected based on the current position and the mode. Next, at step 760, server DHCT 140A waits for an appropriate time interval before transmitting the next trick mode control packet and selected picture frame. The time interval is based on the trick mode (see Table 1). Next, the transmission of trick mode control packet and selected picture frame is repeated, starting at step 730. One skilled in the art will realize that the order of selecting the next frame, creating the control packet, and waiting for transmission can be varied. For example, the wait can occur before the selection, or the control packet can be created before the selection.

FIG. 8 illustrates an example trick mode transport stream 800 created by trick mode logic 290 in server DHCT 140A and transmitted to client DHCT 140B. As described with reference to FIG. 7, trick mode transport stream 800 consists of a combination of trick mode control packets and TS packets selected from stored transport stream 600 (see FIG. 6). The trick mode control packet 810 is encapsulated in a PES packet, which itself is encapsulated in TS packet 820. The control packet starts with a start code, like any other PES packet. Since the control packet is not part of the MPEG standard, start code 830 is set to a reserved value. Also included in control packet 810 is a decoder command 840 and the picture size 850. Both of these items were described earlier in connection with FIG. 7, and also in Table 1. The trick mode control packet 810 is part of the video stream transmitted to client DHCT 140B.

In some embodiments, control packet 810 also contains a trick string describing the trick mode. Examples of trick mode strings include “FFWD”, “PAUS”, “SRWD” (step rewind), “SLMF” (slow motion forward) and “END” (end of trick mode stream). In some embodiments, control packet 810 also contains a time code, which indicates the time at which server DHCT 140A sent the control packet 810. This is a relative time, and is an indication of the speed of the trick mode stream. For example, in a fast-forwardx2 stream, the time code for successive trick mode control packets would be 0, 500, 1000, 1500 (in milliseconds).

The next TS packet in the trick mode transport stream 800, following control packet 810, is TS packet 530A. TS packet 530A contains the start of the first selected picture frame. Next in the transmitted stream is TS packet 530B, which continues the data of the selected picture frame. The selected picture frame ends with TS packet 530D. Server DHCT 140A then transmits some number (M) of TS packets following this end, enough so that the next picture header is transmitted. Next in the stream is another trick mode control packet 860, followed by the TS packet 870 containing the start of the next selected picture frame.

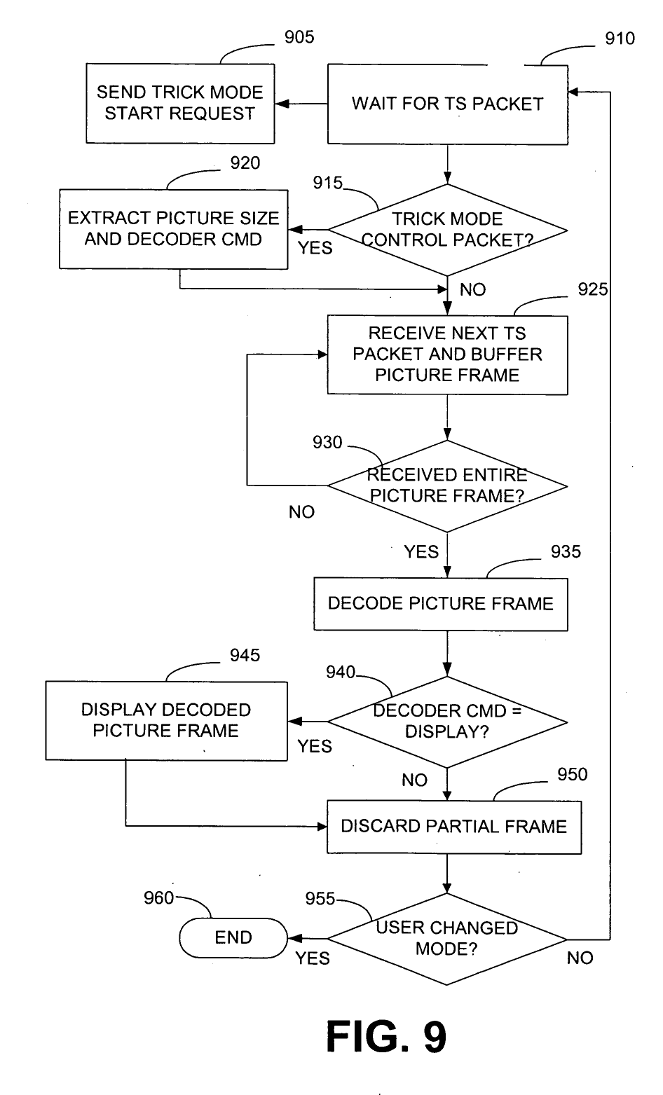

FIG. 9 is a flow chart illustrating the actions taken by trick mode logic 290 in client DHCT 140B in accordance with the method of generating trick mode streams. In this example embodiment, trick mode is initiated by user interaction with client DHCT 140B, for example, by a user pressing a “pause” or “fast-forward” key on remote control 160 (see FIG. 1). As indicated in step 905, client DHCT 140B transmits a trick mode start request to server DHCT 140A over channel 150B. (As noted above, the details of the request protocol are not important to the system and method for generating a trick mode stream.) After transmitting the request, client DHCT 140B waits at step 910 to receive a TS packet.

When a TS packet is received, the process continues at step 915. The contents of the TS packet are examined to determine if the TS packet contains a trick mode control packet 810. If Yes, client DHCT 140B acts in step 920 to extract decoder command 840 and picture size 850 from the received control packet 810. Next, at step 925, client DHCT 140B receives the next TS packet, and buffers the picture frame contained within this TS packet. After receiving the next TS packet, client DHCT 140B determines, at step 930, if all TS packets following this control packet have been received. This determination is made using the picture size 850 in control packet 810, received before the picture frame. If No, client DHCT 140B waits for the next TS packet at step 925.

When the entire picture frame has been received, processing continues at step 935, where the picture frame is decoded. Step 940 then examines decoder command 840 from received control packet 810. If decoder command 840 indicates that the frame should be displayed, this occurs in Step 945. In Step 950, any partial frame received in the accumulated TS packets is discarded. Because picture frames are not required to align on a TS packet boundary, the TS packet containing the end of an I-frame may also contain the start of the next frame (usually a B-frame). In order to discard this partial frame, client DHCT 140B must receive the entire picture header of the partial frame. Having the server DHCT 140A transmit a relatively large number of extra TS packets makes it almost certain that the entire picture header is received. It has been empirically determined that transmitting 10 extra TS packets gives acceptable results (although it is possible that a long header would extend past the tenth packet). Next, client DHCT 140B determines at step 955 if the user has changed modes, for example, from one trick mode to another, or from trick mode to normal play. If Yes, the process ends at step 960. Otherwise, client DHCT 140B returns to step 910 to wait for another TS packet, containing either another control packet 810 or another picture frame.

In the embodiments describe above, the TS packets selected for trick mode transport stream 800 contained I-frames. I-frames are preferred over B-frames or P-frames, since I-frames can be decoded independently. However, it is possible that stored transport stream 600 will not contain any I-frames. An alternative embodiment handles a non-I-frame recorded stream by first instructing the decoder to decode, but not display, a number of P-frames, and later sending a Decode_and_Display instruction. First, a trick mode control packet 810 is constructed with the Decode_Only instruction. This Decode_Only control packet is sent, followed by a complete P-frame. This Decode_Only+P-frame sequence is repeated a number of times (in one embodiment, 12 times).

After receiving this sequence of P-frames, the decoder has buffered and decoded all the P-frames, but has not yet displayed any frames. Next, a Decode_And_Display control packet is sent, followed by an additional complete P-frame. After receiving this additional P-frame, the decoder displays the decoded frames built from the entire sequence of P-frames.

The foregoing description has been presented for purposes of illustration and description. It is not intended to be exhaustive or to limit the disclosure to the precise forms disclosed. Obvious modifications or variations are possible in light of the above teachings. The embodiments discussed, however, were chosen, and described to illustrate the principles of the disclosure and its practical application to thereby enable one of ordinary skill in the art to utilize the invention in various embodiments and with various modifications as are suited to the particular use contemplated. All such modifications and variation are within the scope of the disclosure as determined by the appended claims when interpreted in accordance with the breadth to which they are fairly and legally entitled.

Therefore, having thus described the invention, at least the following is claimed:

1. A server digital home communication terminal (DHCT) configured to create a trick mode stream corresponding to a recorded video stream, the DHCT comprising:
a network interface in communication with a client DHCT, the client DHCT comprising a video decoder;
a storage medium;
at least one memory having stored thereon program code; and
at least one processor that is programmed by at least the program code to enable the server DHCT to:
select a first encoded picture frame from the recorded video stream on the storage medium;
retrieve a first sequence of transport packets encapsulating the first picture frame;
create a first transport packet containing a first client control packet associated with the first picture frame, the first client control packet comprising the size of the first picture frame and a decoder command for the video decoder; and
transmit, to the video decoder, a trick mode stream comprising the first transport packet followed by the first sequence of transport packets.

2. The server DHCT of claim 1, wherein the decoder command instructs the video decoder whether or not the first picture frame is displayed after decoding.

3. The server DHCT of claim 1, wherein the first encoded picture frame is an MPEG I-frame.

4. The server DHCT of claim 3, wherein the decoder command instructs the video decoder to display the MPEG I-frame after decoding.

5. The server DHCT of claim 1, wherein the encoded picture frame comprises a presentation timestamp, and the control packet instructs the video decoder to display the encoded picture frame at a time based on receiving the encoded picture frame and not on the presentation timestamp.

6. The server DHCT of claim 1, wherein the at least one processor is further programmed to enable the server DHCT to:
retrieve a second sequence of transport packets encapsulating a picture header of a second encoded picture frame, the second picture frame immediately following the first picture frame; and
transmit, to the video decoder, the second sequence of transport packets.

7. The server DHCT of claim 1, wherein the at least one processor is further programmed to enable the server DHCT to:
receive a trick mode command from the client DHCT;
select, based on the trick mode command, a third encoded picture frame from the recorded video stream on the storage medium;
retrieve a third sequence of transport packets encapsulating the third picture frame;
create a second transport packet containing a second client control packet associated with the second picture frame, the second client control packet comprising the size of the third picture frame and a command for the video decoder; and
transmit, to the video decoder, the second transport packet followed by the third sequence of transport packets.

8. The server DHCT of claim 7, wherein the trick mode command specifies a mode, a direction, and a speed.

9. The server DHCT of claim 8, wherein the at least one processor is further programmed to enable the server DHCT to:
transmit, to the video decoder, at a time based on the speed, the third sequence of transport packets encapsulating the third picture frame.

10. The server DHCT of claim 1, wherein the at least one processor is further programmed to enable the server DHCT to:
select a sequence of P-frames from the recorded video stream on the storage medium;
retrieve a plurality of sequences of transport packets, each sequence encapsulating one of the P-frames; and
for each P-frame in the sequence of P-frames, transmit to the video decoder a command instructing the video decoder to decode but not display the corresponding P-frame, followed by the sequence of transport packets encapsulating the corresponding P-frame.

11. The server DHCT of claim 10, wherein the at least one processor is further programmed to enable the server DHCT to:
after transmitting the plurality of sequences of transport packets,
select an additional P-frame from the recorded video stream on the storage medium;
retrieve a fourth sequence of transport packets encapsulating the additional P-frame;
transmit, to the video decoder, a transport packet containing a command instructing the video decoder to decode and display the additional P-frame; and
transmit, to the video decoder, the fourth sequence of transport packets.

12. A client digital home communication terminal (DHCT) configured to receive a trick mode stream corresponding to a recorded video stream, the DHCT comprising:
a network interface in communication with a server DHCT;
at least one memory having stored thereon program code; and
at least one processor that is programmed by at least the program code to enable the client DHCT to:
receive, via the network interface, a first transport packet containing a first client control packet associated with a first picture frame, the first client control packet comprising the size of the first picture frame and a decoder command;
receive a sequence of transport packets containing the first picture frame;
decode the received first picture frame; and
display the decoded picture frame if the decoder command indicates the frame is to be displayed.

13. The client DHCT of claim 12, wherein the at least one processor is further programmed to enable the client DHCT to refrain from decoding until the entire sequence of transport packets containing the first picture frame is received.

14. The client DHCT of claim 12, wherein the at least one processor is further programmed to enable the client DHCT to:
extract picture data from each of the sequence of received transport packets;
buffer the picture data; and
responsive to the size of the buffered data reaching the size in the first client control packet, decode the buffered picture data.

15. The client DHCT of claim 12, wherein the at least one processor is further programmed to enable the client DHCT to:
determine if a received transport packet contains a trick mode control packet;
responsive to the determining, extract the trick mode control packet from the received transport packet; and
extract the first picture frame size and the decoder command from the trick mode control packet.

16. The client DHCT of claim 12, wherein the at least one processor is further programmed to enable the client DHCT to:
receive, after the first picture frame, one or more transport packets containing a partial picture frame; and
discard, without decoding, the partial picture frame.

17. The client DHCT of claim 12, wherein the received first picture frame comprises a presentation timestamp, and the at least one processor is further programmed to enable the client DHCT to display the decoded picture when decoding is complete and not at a time based on the presentation timestamp.

18. The client DHCT of claim 12, further comprising:
an input interface configured to receive user input comprising a trick mode command;
wherein the at least one processor is further programmed to enable the client DHCT to request, responsive to the trick mode command, a trick mode stream from the server DHCT via the network interface.

19. The client DHCT of claim 18, wherein the trick mode command specifies a mode, a direction, and a speed.
